(19) United States
(12) Patent Application Publication
(10) Pub. No.: US 2016/0032440 A1
(43) Pub. Date: Feb. 4, 2016

(54) PROCESS FOR FABRICATING AN AIRCRAFT PART COMPRISING A SUBSTRATE AND A SUBSTRATE COATING LAYER

(71) Applicant: MESSIER-BUGATTI-DOWTY, Velizy-Villacoublay (FR)

(72) Inventors: Francis MONERIE-MOULIN, Prechacq-Josbaig (FR); Regis GAYDU, Oloron Sainte Marie (FR)

(73) Assignee: MESSIER-BUGATTI-DOWTY, Velizy Villacoublay (FR)

(21) Appl. No.: 14/766,185

(22) PCT Filed: Feb. 13, 2014
(86) PCT No.: PCT/EP2014/052855

§ 371 Date: Aug. 6, 2015

(30) Foreign Application Priority Data
Feb. 15, 2013 (FR) 13 51336

(51) Int. Cl. C23C 4/12; G01B 21/30; C23C 4/06; C23C 4/18; C23C 4/02

(52) U.S. Cl. CPC C23C 4/124; C23C 4/18; C23C 4/02; C23C 4/06; G01B 21/30

(57) ABSTRACT

A method of fabricating a part (1) comprising a metal substrate (Sub) at least partially covered in a coating layer (Rev). The method comprises: preparing (A) a surface of the substrate (Sub) to obtain a prepared surface of roughness Ra lying in the range 0.6 μm to 1.6 μm, and; forming (C) the coating layer (Rev) on the prepared surface of the substrate, this coating layer (Rev) being formed by spraying, using an HVOF type spraying method to spray a powder mixture containing grains (G) of metal carbide, the grains (G) having dimensions that are strictly less than 1 μm and the thickness (Epmin) of the coating layer (Rev) as formed in this way being less than 50 μm; then finishing at least one surface of said coating layer (Rev) by polishing (D) in such a manner as to ensure that its roughness Ra is less than 1.6 μm.

The invention relates to a method of fabricating parts, such as aviation parts, comprising a substrate that is coated at least in part by a coating layer protecting the substrate.

### BACKGROUND OF THE INVENTION

By way of example, methods are known for fabricating parts that include applying a coating layer of chromium onto a metal substrate by means of a metal bath, the coating layer serving both to protect the substrate and also to give it functional roughness. It is desired to minimize wear of the chromium since that is harmful for health and the environment.

### OBJECT OF THE INVENTION

An object of the present invention is to propose a method of fabricating a part comprising a substrate and a layer of coating formed on a surface of the substrate, the method making it possible to minimize, and preferably to eliminate, any need for chromium in the coating.

### SUMMARY OF THE INVENTION

The invention relates essentially to a method of fabricating a part comprising a metal substrate at least partially covered in a coating layer, the method comprising:
preparing a surface of the substrate for covering in order to obtain a prepared surface of roughness Ra lying in the range 0.6 micrometers (μm) to 1.6 μm, and preferably in the range 0.8 μm to 1.6 μm;
forming the coating layer on the prepared surface of the substrate, this coating layer being formed by spraying, using a high velocity oxi-fuel (HVOF) type spraying method to spray a powder mixture containing grains of at least one metal carbide, the grains having dimensions that are strictly less than 1 μm and the thickness of the coating layer as formed in this way being less than 50 μm; then
finishing at least one surface of said coating layer by polishing (D) in such a manner as to ensure that its roughness Ra is less than 1.6 μm.

In order to be sure that the thickness of the coating that has been formed does indeed lie within the predetermined thickness range, measurements are taken at a plurality of points by induction or by eddy currents, thereby obtaining minimum and maximum thickness values for the layer (roughness troughs). The thickness value of the layer required for performing the method of the invention is a mean of those various point measurements, it being understood that none of the point measurements may exceed a layer thickness of 55 μm.

For understanding the invention, the roughness Ra is the arithmetic mean difference between the profile of the surface having its roughness measured and the mean line of the profile. This value for the roughness Ra is obtained by taking a series of measurements along the profile using a method described below.

A spray method of the HVOF type is a method of spraying a powder mixture containing grains by using combustion gas obtained by burning a fuel with an oxidizer. The speed and the temperature of such a gas are such that the grains of the mixture are pulverized (here grains of metal carbide) and they are ejected against the substrate with sufficient energy to attach thereto, thereby forming a coating layer on the substrate. Typically, in an HVOF spray method, the combustion gas has supersonic speed.

Surprisingly, by combining a layer thickness that is small (less than 50 μm and preferably greater than 30 μm), with grain size that is small (dimensions strictly less than 1 μm and preferably of the order of 450 nanometers (nm)±50 nm for mean grain size, where mean grain size is the grain size of at least 50% of the weight of the grains) and with a level for the roughness Ra of the substrate of less than 1.6 μm, the invention obtains several advantages:
A reducing the risk of the layer formed on the substrate breaking/detaching;
B maintaining a level of protection against corrosion; and
C reducing the time required for spraying the layer and reducing the weight of the layer formed in this way.

It should also be observed that the invention makes it possible to omit a step of grinding that has traditionally been used for adjusting the shape of the coating layer and for adjusting its surface state. Thus, the method of the invention makes it possible, as from the spraying step, to generate a layer thickness that is directly of the desired dimension plus a little extra that is to be removed by polishing, without any need to adjust this dimension by grinding. It should be observed that the step of finishing the coating layer by polishing serves to remove a thickness that is strictly less than 20 μm, and preferably lies in the range 5 μm to 10 μm (which value corresponds to the extra thickness), whereas grinding removes at least 30 μm, with these two operations thus not being comparable in their effects.

### A On Reducing the Risk of the Layer Breaking/Detaching as a Result of Repeated Mechanical Stresses

Under the effect of repeated mechanical stresses on the assembly comprising the substrate and the layer, the coating layer tends to crack in its thickness direction, and then little by little to become delaminated and to detach in flakes. This phenomenon is known as “spalling”. This spalling phenomenon is made worse by increasing the thickness of the layer and by increasing the stresses applied to the layer. Consequently, and surprisingly, the method of the invention makes it possible to increase the ability of the layer to withstand stresses even though it involves reducing the thickness of the layer.

It is found that by reducing the size of the grains, a microstructure is obtained that is finer with better resistance to spalling than when using grains of the usual sizes, which have a mean grain size greater than 5 μm.

It is found that by reducing the thickness of the layer, the spalling phenomenon is also reduced, since the layer has less tendency to crack transversely and since the total shear force transmitted at the interface is smaller.

Thus, by limiting both the size of the grains and also the thickness of the layer, and by adjusting the roughness of the substrate prior to applying the layer, the invention limits any risk of spalling.

Whereas the thickness of the layer is traditionally greater than 75 μm, it is found that by reducing its thickness to less than 50 μm, the invention serves to limit corrosion of the substrate as a result of spalling.

### B On Maintaining or Even Improving Protection against Corrosion

As mentioned above, the coating layer is obtained by heating and spraying the powder mixture against the substrate for coating. The powder mixture reaches the substrate in the form of drops in the molten state or at least in a soft state. Each drop flattens out on the substrate and forms one or more lamellar particles. These lamellar particles are commonly known to the person skilled in the art as “splats”. It is found that by limiting the mean size of the grains of carbide present in the powder mixture, a microstructure is obtained that is finer, having a larger number of lamellar particles than would be obtained by spraying carbide grains of greater mean sizes.

Thus, the layer made by the method of the invention, which has thickness lying in the range 30 μm to 50 μm and which contains metal carbide grains of dimensions smaller than 1 μm, and preferably smaller than 600 nm, more preferably less than 450 nm, and preferably having a mean grain size of 400 nm±50 nm, presents a mean number of superposed lamellar particles that is not less than the number of particles in a 75 μm coating layer obtained using grains having a size of several micrometers.

For constant layer thickness, by increasing the mean number of superposed lamellar particles, the risk of passages appearing through the layer is reduced, and consequently a level of protection against corrosion is maintained that is at least equivalent to that found for a layer thickness that is greater and made using grains having a size of several micrometers.

### C On Reducing the Time Required for Spraying and Reducing the Weight of the Resulting Layer

Furthermore, by limiting the thickness of the layer, the invention makes it possible to lighten the weight of the part without compromising its ability to withstand corrosion.

For all of these reasons, the method of the invention is particularly suitable for protecting an aircraft landing gear rod, which needs to be light in weight (in order to reduce aircraft fuel consumption), to be capable of withstanding varying mechanical loads, to be capable of withstanding large temperature variations, and to present good resistance to corrosion, while limiting any risk of spalling appearing, which can lead to hydraulic fluid becoming polluted by particles from the coating and to losses of sealing.

### BRIEF DESCRIPTION OF THE DRAWING

The invention can be better understood in the light of the following description of a particular implementation given with reference to the accompanying figures, in which:

FIG. 1 shows a part made using the method of the invention, specifically a landing gear rod having a cylindrical surface portion covered in an annular coating layer serving to provide protection against corrosion and to provide a surface on which a gasket slides;

FIG. 2 is an enlarged cross-section view of a portion of the landing gear rod of FIG. 1, showing the substrate and the coating layer; and

FIG. 3 is a logical diagram showing the steps of the method of the invention.

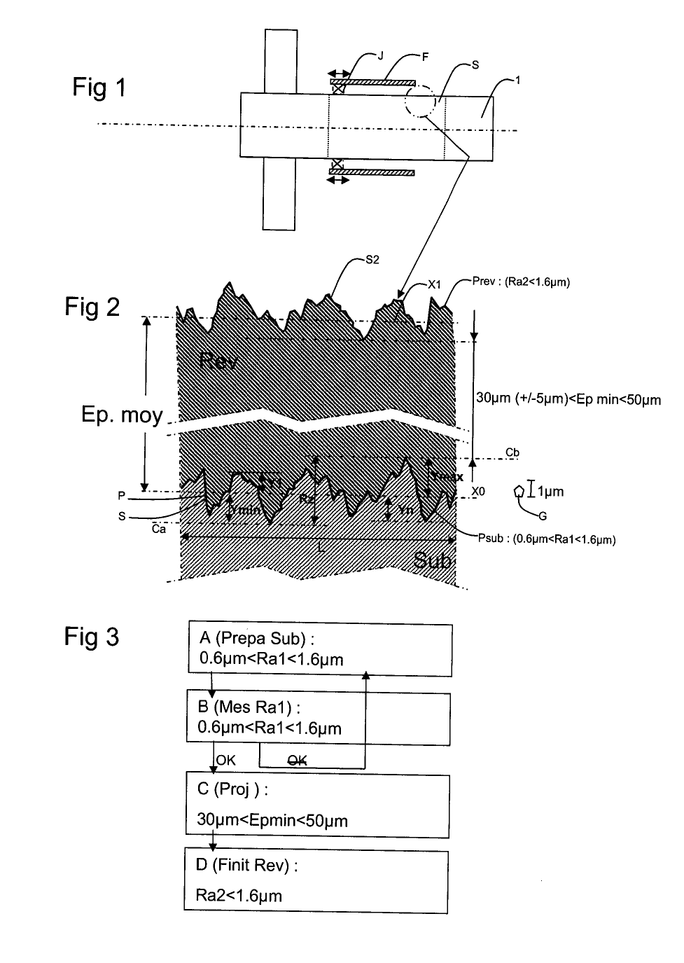

### DETAILED DESCRIPTION OF THE INVENTION

As mentioned above, the fabrication method of the invention is preferably used for producing a landing gear rod 1. This landing gear rod is generally made from a forging that is then machined to present at least one right cylindrical portion. This right cylindrical portion Sub is coated in an annular coating layer Rev that is to rub against gaskets J to allow the rod 1 to slide relative to a strut F of the landing gear. This coating layer Rev must both provide the rod 1 with protection against corrosion and sealing between the rod 1 and the strut F in order to limit any risk of hydraulic fluid leaking.

It should be observed that the substrate Sub is a metal alloy of the steel or titanium type.

As can be seen in FIG. 3, the method of fabricating the part 1 comprises:
preparing A (Prepa Sub) a surface S for covering of the substrate Sub in such a manner that its roughness Ra lies in the range 0.6 μm to 1.6 μm, and preferably in the range 0.8 μm to 1.6 μm;
measuring B (Mes Ra1) to make sure that the prepared surface does indeed have the required roughness Ra1; then
forming C (Proj) the coating layer Rev on the prepared surface S of the substrate, this coating layer

Rev being formed by HVOF type spraying Proj of a powder mixture containing grains G of metal carbide, these grains G having dimensions that are strictly less than 1 μm and the minimum thickness Epmin of the coating layer Rev that is formed in this way is less than 50 μm and greater than 30 μm; and then
finishing by polishing D (Finit Rev) at least one surface S2 of said coating layer Rev so as to ensure that its roughness Ra is less than 1.6 μm (the roughness Ra of the coating layer Rev is written Ra2).

The step A of preparing the surface S of the substrate Sub is performed by sand blasting.

The step C of forming the coating layer is performed by HVOF spraying of a powder mixture. The powder mixture contains grains of metal carbide coated in a binder, specifically tungsten carbide WC coated in cobalt Co and chromium Cr. The cobalt Co serves as a binder and the chromium Cr provides protection against oxidation. This powder mixture is in the form of agglomerates/aggregates having a maximum grain size of less than 50 μm and preferably a mean grain size lying in the range 10 μm to 30 μm (more than 50% of the weight of the powder mixture is made up of aggregates having grain size lying in the range 10 μm to 30 μm). The agglomerates are generally made by sintering so as to create bridges between the carbide and the binder material. The sintering is generally performed in an oven in order to melt the binder without decarbiding the grains of metal carbide.

Ideally, the grains of metal carbide WC present in the powder mixture are calibrated to have dimensions that are strictly less than 1 μm, preferably less than 600 nm, and preferably less than 450 nm. Ideally, the mean grain size of the grains is 400 nm±50 nm.

After forming the coating layer Rev with the desired thickness, the polishing operation D (Finit Rev) is performed by means of a belt. This step serves to detach grains that are poorly attached and to guarantee that the roughness level Ra2 is less than 1.6 μm. During polishing, the layer is reduced by no more than 10 μm. Thus, the minimum thickness Epmin of the layer Rev after polishing is greater than 20 μm.

The annular coating layer as formed in this way contains metal carbide grains of sizes that are exclusively less than 1 μm and a cobalt, chromium binder. It should be observed that the present invention can be performed with other types of chemical composition containing at least one metal carbide and at least one binder. Among possible examples of compositions, mention may be made of WCCo that may be in the form of a mixture of 83% WC and 17% Co or in the form of a mixture of 88% WC and 12% Co, and mention may also be made of WCCrC Ni.

It should be observed that a step of grinding the layer is conventionally needed in order to true the layer, i.e. in order to obtain a given shape and surface state for the layer.

Unfortunately, grinding an annular layer formed on a portion of right cylindrical shape requires the layer to have considerable thickness so as to guarantee that, after the grinding, there remains some minimum thickness of the layer on the substrate.

By eliminating the step of grinding the annular layer, the method of the invention makes it possible to obtain the desired layer thickness directly without any need to perform grinding, thereby eliminating the risk of defects appearing due to the grinding (grinding a cylindrical annular layer frequently leads to the appearance of zones in which the layer is too thin because of uncertainties in positioning the part on the grinder machine, and these zones are difficult to detect but likely to lead to premature corrosion of the substrate). The invention makes it possible to eliminate this risk of having a layer that is locally too thin in non-detectable manner.

As can be seen in FIG. 3, prior to the formation of the coating layer Rev on the substrate Sub, a measurement B (Mes Ra1) is performed of the roughness Ra1 of the surface S of the substrate Sub. If this measured roughness Ra1 lies between predetermined minimum and maximum thresholds, it is then possible to form the coating layer Rev. If not, if the measured roughness of the surface S of the substrate is less than the minimum predetermined threshold or greater than the maximum predetermined threshold, then preparation of the surface S is continued until it presents roughness lying between the predetermined minimum and maximum thresholds.

The minimum threshold is 0.6 μm or preferably 0.8 μm, and the maximum threshold roughness is 1.6 μm. The minimum threshold is set to ensure that the grains G sprayed onto the surface S attach securely.

The maximum threshold is set so as to limit degradation of the surface S2 of the coating Rev as a result of roughness defects R1 in the surface S of the substrate Sub. Since the coating layer Rev is thin (less than 50 μm), and since the grains are of small grain size (less than 1 μm) relative to the looked-for roughness values Ra (less than 1.6 μm), the roughness of the surface S2 obtained after HVOF spraying is substantially identical to the roughness of the surface R1 of the surface S. This explains the advantage of setting the maximum threshold for the roughness R1 of S at 1.6 μm, which is the roughness threshold desired for the surface S2 of the coating Rev. Mere polishing of the surface S2 of the coating then makes it possible to obtain the desired roughness of 1.6 μm.

Thus, the aircraft landing gear rod that is obtained using the method of the invention presents a cylindrical zone with coating Rev of hardness on the Vickers scale that is greater than 950 Hv, which is sufficient to limit friction wear of the gasket J.

Furthermore, by limiting the thickness of the layer to 50 μm and preferably to lie in the range 30 μm to 50 μm, a superposition of at least 20 coated grains of 1 μm size is obtained on average. With such a superposition, protection against corrosion is obtained that is compatible with the part being exposed for at least 500 hours to saline mist.

### On Measuring the Roughness Ra

It should be recalled that the roughness Ra of the surface is the arithmetic mean difference between the profile of the surface and the mean line X0 of the profile of length L. The value of Ra is given by the following formula:

$$Ra = \frac{1}{L} {\int }_{0}^{L} \vert y ( x ) \vert d x$$

where:
L represents the base length of the measured profile;
n represents the number of measurements taken along the length of the profile L; and
y(x) is the distance between the mean line X0 of the profile and the profile at the position along the profile of abscissa value x (where x lies in the range 0 to L).

The mean line X0 is a straight line having the same general direction as the profile over the length of the profile having its roughness measured. As can be seen in FIG. 2, this line X0 divides the profile in such a manner that on the base length L, the sum of the squares of the differences between the profile and this line is minimized (“line of the least squares”). In other words, this line X0 is positioned in such a manner that over the length L on the cross-section plane of the profile, the sum of the areas lying between the mean line X0 and the profile is equal on both sides of the line X0.

This value for Ra can also be approximated using the following formula:

$$Ra \approx \frac{\vert y 1 \vert + … + \vert yn \vert }{n}$$

where:
yn is the distance between the mean line X0 of the profile and the profile measured during an n^{th} measurement. The number of measurements goes from 1 to n along the length L of the measured profile. Either of these measurement techniques for measuring the roughness Ra can be used in order to perform the invention, but the second is preferred since it does not require the profile to be measured continuously.

In FIG. 2, which is a section view of the profile Psub of the substrate Sub, there can be seen measured values y1 and yn for the profile difference P relative to the mean line X0, together with values Ymin and Ymax.

Ymin corresponds to the maximum difference observed between the line Ca of the trough of the profile P and X0.

Ymax corresponds to the maximum difference observed between the line Cb of the crests of the profile of the substrate and X0.

Rz is the maximum height of the profile and is equal to Ymin+Ymax.

X1 is the mean line of the profile of the coating Rev.

As mentioned above, and surprisingly, by adjusting the roughness of the substrate and by reducing the thickness of the layer, it is found that the layer withstands spalling better than would a layer of greater thickness.

By means of all these characteristics, the method of the invention makes it possible to obtain a finished part of lighter weight, that is less expensive, and that is stronger, while keeping intact the characteristics that are necessary for good sealing between the part 1 and the gaskets J.

It should be observed that the carbide grains used could be made of a type of metal carbide other than tungsten carbide and that the binder materials could be made of materials other than chromium and cobalt.

1. A method of fabricating a part (1) comprising a metal substrate (Sub) at least partially covered in a coating layer (Rev), the method comprising:
preparing (A) a surface of the substrate (Sub) for covering in order to obtain a prepared surface of roughness Ra lying in the range 0.6 μm to 1.6 μm, and preferably in the range 0.8 μm to 1.6 μm;
forming (C) the coating layer (Rev) on the prepared surface of the substrate, this coating layer (Rev) being formed by spraying, using an HVOF type spraying method to spray a powder mixture containing grains (G) of metal carbide, the grains (G) having dimensions that are strictly less than 1 μm and the thickness (Ep min) of the coating layer (Rev) as formed in this way being less than 50 μm; then
finishing at least one surface of said coating layer (Rev) by polishing (D) in such a manner as to ensure that its roughness Ra is less than 1.6 μm.

2. A method according to claim 1, wherein the preparation (A) of the substrate surface (Sub) for covering is performed by sand blasting.

3. A method according to claim 1, wherein the coating layer that is formed has thickness lying in the range 30 μm to 50 μm and the size of the metal carbide grains is less than 600 nm, preferably less than 450 nm.

4. A method according to claim 1, wherein the part is an aircraft landing gear rod, the coating layer being annular and covering a right cylindrical portion of the part.

5. A method according to claim 1, wherein, prior to forming the coating layer (Rev) on the substrate (Sub), the roughness (Ra1) of the surface (S) of the substrate (Sub) is measured (B), and if this measured roughness lies between predetermined minimum and maximum thresholds, then the coating layer can be formed, whereas if this measured roughness of the substrate surface is less than the predetermined minimum threshold or greater than the predetermined maximum threshold, then preparation of the surface is continued until it presents measured roughness (Ra1) lying between the predetermined minimum and maximum thresholds.

6. A method according to claim 1, wherein the metal alloy of the substrate (Sub) is a steel alloy or a titanium alloy.

7. A method according to claim 1, wherein the polishing operation (D) is performed by means of a belt using an abrasive.

8. A method according to claim 1, wherein the powder mixture is constituted by a metal carbide and a binder for the carbide.

9. A method according to claim 8, wherein the metal carbide is WC and the binder comprises Co and Cr.

10. A method according to claim 8, wherein the powder mixture is in the form of agglomerates having a maximum grain size of less than 50 μm, with preferably at least 50% of the weight of the powder mixture being constituted by agglomerates of grain size lying in the range 10 μm to 30 μm.

11. A part made according to the method of claim 1.
